(19) United States
(12) Patent Application Publication
(10) Pub. No.: US 2026/0272031 A1
(43) Pub. Date: Sep. 17, 2026

(54) HEATING ASSEMBLY AND ELECTRIC HEATING SMOKING SET

(71) Applicant: SHENZHEN FIRST UNION TECHNOLOGY CO., LTD., Shenzhen (CN)

(72) Inventors: Zexin WU, Shenzhen (CN); Zhongli XU, Shenzhen (CN); Yonghai LI, Shenzhen (CN)

(73) Assignee: SHENZHEN FIRST UNION TECHNOLOGY CO., LTD., Shenzhen (CN)

(21) Appl. No.: 19/668,574

(22) Filed: May 5, 2026

Related U.S. Application Data
(63) Continuation of application No. 17/758,305, filed on Dec. 31, 2020, now Pat. No. 12,642,299.

(30) Foreign Application Priority Data
Jan. 3, 2020 (CN) 202020017338.9

(51) Int. Cl. A24F 40/46; H05B 3/46

(52) U.S. Cl. CPC A24F 40/46; H05B 3/46

(57) ABSTRACT

A heating tube and an electronic smoking set. The heating tube includes: a tube body having a first end and a second end, a heating part, and a conductive part comprising a first conductive part and a second conductive part. The first conductive part comprises a first electrode part and a first extension part. The first extension part extends from the first electrode part towards the second end. The second conductive part comprises a second electrode part and a second extension part. The second extension part extends from the second electrode part towards the second end. An average circumferential width of the first electrode part is larger than an average circumferential width of the first extension part; and an average circumferential width of the second electrode part is larger than an average circumferential width of the second extension part.

### CROSS REFERENCE TO RELATED APPLICATIONS

This application is a continuation of U.S. application Ser. No. 17/758,305 filed on Jul. 1, 2022, which is a 371 national entry of PCT/CN 2020/142212 filed on Dec. 31, 2020, which claims priority to Chinese Patent Application No. 202020017338.9, entitled “Heating assembly and electric heating smoking set” and submitted to China National Intellectual Property Administration on Jan. 3, 2020, the entire contents of each of which are incorporated herein by reference for all purposes.

### TECHNICAL FIELD

The embodiment of the present disclosure relates to the technical field of smoking sets, and in particular to a heating assembly and an electric heating smoking set.

### BACKGROUND

Electric heating smoking set is one of electronic cigarette products, for example, the electric heating smoking set is a low-temperature smoking set; the low-temperature smoking set refers to one configured to heat a cigarette in a low-temperature nonburning mode so that the cigarette can be inhaled.

Some electric heating smoking set products generally include a heating assembly and a power source, the power source is electrically connected to the heating assembly so that the power source provides a power support for the heating assembly. The heating assembly is mainly configured to generate heat to heat a cigarette or an e-liquid matrix. However, the heat generated by the heating assembly is easy to cause impact on the electric connection between parts, particularly on the welded structure point between parts; when the temperature is too high, the welded structure point is prone to damage, thereby causing circuit interruption between parts.

### SUMMARY

The embodiment of the present disclosure aims to provide a heating tube and an electronic smoking set.

The embodiment of the present disclosure employs the following technical scheme.

There is provided a heating tube, including:
a tube body having a first end and a second end that is opposite to the first end, a heating part, and a conductive part comprising a first conductive part and a second conductive part, wherein:
the first conductive part and the second conductive part are disposed on the tube body and are in electrical connection with the heating part;
the first conductive part comprises a first electrode part and a first extension part;
the first electrode part is closer to the first end than the first extension part;
the first extension part extends from the first electrode part towards the second end;
the second conductive part comprises a second electrode part and a second extension part;
the second electrode part is closer to the first end than the second extension part;
the first extension part extends from the first electrode part towards the second end and at least a part of the first extension part is in direct contact with the heating part;
the second extension part extends from the second electrode part towards the second end;
an average circumferential width of the first electrode part is larger than an average circumferential width of the first extension part; and
an average circumferential width of the second electrode part is larger than an average circumferential width of the second extension part.

In addition, the embodiment of the present disclosure further provides an electronic smoking set, including:
the heating tube as described above;
a power source, which is configured to supply power to the heating tube.

### BRIEF DESCRIPTION OF THE DRAWINGS

One or more embodiments are illustrated through the image(s) in corresponding drawing(s). These illustrations do not form restrictions to the embodiments. Elements in the drawings with a same reference number are expressed as similar elements, and the images in the drawings do not form proportional restrictions unless otherwise stated.

FIG. 1 is a structural diagram of an electric heating smoking set according to an embodiment of the present disclosure.

FIG. 2 is a sectional view of FIG. 1.

FIG. 3 is a structural diagram of a heating assembly shown in FIG. 2.

FIG. 4 is an exploded view of FIG. 3.

FIG. 5 is a structural diagram of another heating assembly according to an embodiment of the present disclosure.

FIG. 6 is a structural diagram of another heating tube according to an embodiment of the present disclosure.

FIG. 7 is a structural diagram of yet another heating assembly according to an embodiment of the present disclosure.

FIG. 8 is a structural diagram of still yet another heating assembly according to an embodiment of the present disclosure.

### DETAILED DESCRIPTION

The present disclosure will become better understood from a more detailed description of the present disclosure below taken in conjunction with drawings and particular embodiments. It is to be noted that when an element is described as “fixed to” another element, it may be directly on the another element, or there might be one or more intermediate elements between them. When one element is described as “connected to” another element, it may be directly connected to the another element, or there might be one or more intermediate elements between them. The orientation or position relations indicated by such terms as “upper”, “lower”, “inner”, “outer”, “vertical” and “horizontal” used in the description are based on the orientation or position relations shown in the drawings, and are merely for conveniently describing the present disclosure and simplifying the description, rather than indicating or implying that the device or element must have the specific orientation and be constructed and operated according to the specific orientation. Therefore, they should not be construed as a limitation on the present disclosure. In addition, terms such as “first”, “second”, etc. are used merely for the purpose of description, and should not be construed as indicating or implying the degrees of importance.

Unless otherwise defined, all technical and scientific terms used in this description have the same meaning as those normally understood by the skill in the technical field of the present disclosure. The terms used in this description of the present disclosure are just for the purpose of describing particular embodiments, rather than limiting the present disclosure. Terms “and/or” used in the present disclosure include any and all combinations of one or more listed items.

In addition, technical features involved in different embodiments of the present disclosure described below may be combined mutually if no conflict is incurred.

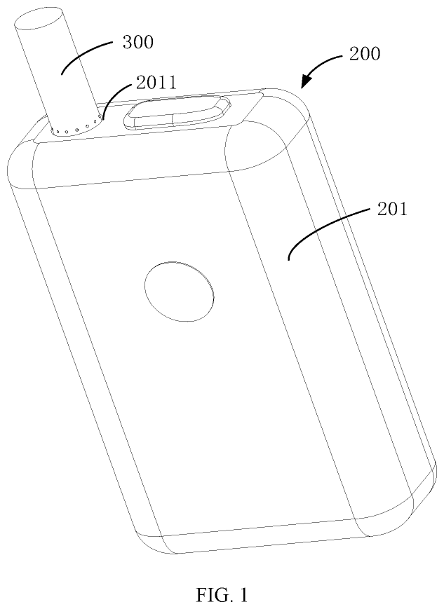

Referring to FIG. 1 to FIG. 4, an embodiment of the present disclosure provides an electric heating smoking set 200, which is one of electronic cigarettes. For example, the electric heating smoking set 200 is a low-temperature smoking set, it is understandable that the low-temperature smoking set refers to one configured to heat a cigarette 300 in a low-temperature nonburning mode so that the cigarette 300 can be inhaled. Alternatively, the electric heating smoking set 200 is configured to heat an e-liquid matrix to form an inhalable aerosol.

An embodiment of the present disclosure provides a heating assembly 100, which is applicable to the electric heating smoking set 200 shown in FIG. 1.

Hereinbelow, the technical scheme of the present disclosure is described in detail by taking the electric heating smoking set 200 being a low-temperature smoking set as an example.

The electric heating smoking set 200 includes a shell 201, a power source 202, a control circuit board 203 and the heating assembly 100. The power source 202 is coupled with the heating assembly 100, to provide power support for the heating assembly 100. For example, the power source 202 is electrically connected to the control circuit board 203, and the control circuit board 203 is electrically connected to the heating assembly 100, so that the power source 202 can provide power support for the heating assembly 100. It is understandable that the control circuit board 203 may be provided with multiple functional circuits, for example, the control circuit board 203 is connected to an over-temperature protection circuit; when the temperature of the heating assembly 100 is higher than a preset temperature, the over-temperature protection circuit interrupts the electric connection between the power source 202 and the heating assembly 100. The power source 202 and the heating assembly 100 are together housed within the shell 201 and are fixedly mounted into the shell 201. The shell 201 defines a through insertion hole 2011, the insertion hole 2011 corresponds to the heating assembly 100 in terms of position, the cigarette 300 may enter inside of the shell 201 through the insertion hole 2011 and abuts against the heating assembly 100, so that the heating assembly 100 can heat the cigarette 300 in a low-temperature nonburning mode.

The heating assembly 100 includes a heating tube 10 and at least one base 20. The heating tube 10 is detachably mounted on the base 20, and the base 20 is fixedly mounted with the shell 201.

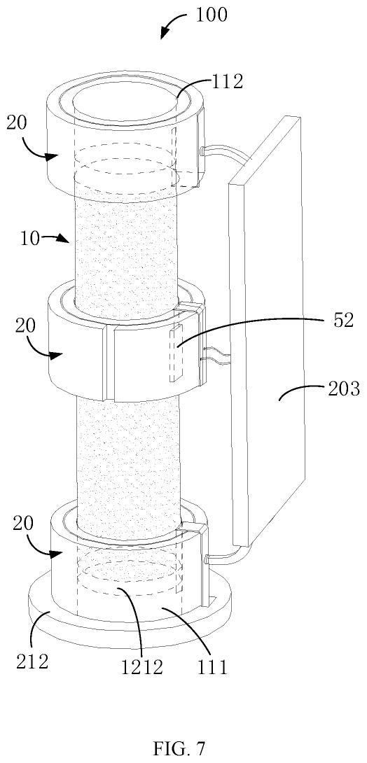

Referring to FIG. 7, in some other embodiments, the heating tube 10 is connected to three bases 20, wherein two of the bases 20 are located on two ends of the heating tube 10 respectively, and one of the bases 20 is located on the middle of the heating tube 10. Optionally, the heating assembly 100 further includes a temperature sensor 52, and the temperature sensor 52 is mounted on the base 20 and pressed on the heating tube 10. The temperature sensor 52 is configured to detect the temperature of the heating tube 10, so as to perform intelligent control on the heating tube 10 to thus achieve the technical purpose of intelligent control of temperature.

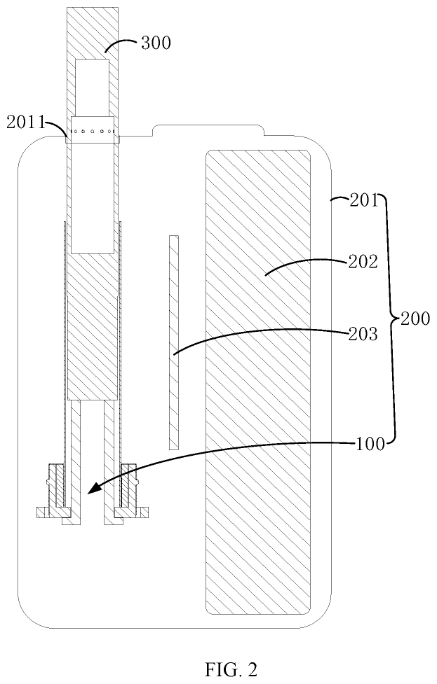

Referring to FIG. 2 to FIG. 4, the heating tube 10 presents a straight-line shaped structure, the power source 202 presents a straight-line shaped structure, the heating tube 10 and the power source 202 are in a parallel arrangement transversely, such that a compact spatial layout is enabled between each part of the electric heating smoking set 200, being conducive to miniaturization of the product. Here, both of the control circuit board 203 and the power source 202 are located on one same side of the heating tube 10, meanwhile the control circuit board 203 is located between the heating tube 10 and the power source 202. Optionally, the power source 202 is fixedly mounted on partial inside wall of the shell 201, the control circuit board 203 may be fixedly mounted on the power source 202, and the heating assembly 100 is fixedly mounted on another partial inside wall of the shell 201.

The heating tube 10 is a cylindrical tubular structure, and the heating tube 10 includes a tube body 11, a heating part 13 and a conductive part 12. The tube body 11 includes a first end part 111, a second end part 112, and a heating channel 113 running through the tube body 11. The heating channel 113 is of a straight-line shaped structure, wherein one opening of the heating channel 113 is located on the first end part 111, while the other opening of the heating channel 113 is located on the second end part 112. In the present embodiment, the one opening of the heating channel 113 located on the second end part 112 is aligned to the insertion hole 2011, the cigarette 300 is inserted into the heating channel 113 through the insertion hole 2011, the cigarette 300 is partially accommodated into the heating channel 113, and the cigarette 300 is heated within the heating channel 113. Optionally, the hole shape of the heating channel 113 is similar to the shape of the cigarette 300, and the heating channel 113 is a circular duct.

The tube body 11 is provided with the heating part 13, the heating part 13 is configured to generate heat in the condition of electrical conduction, so as to heat the cigarette 300 accommodated within the heating chamber 113. Optionally, the heating tube 10 is an electric heating tube, the heating part 13 includes a resistor heating circuit layer 131 attached on the surface of the tube body 11 that is configured to generate heat, and the resistor heating circuit layer 131 generates heat under the action of electric current.

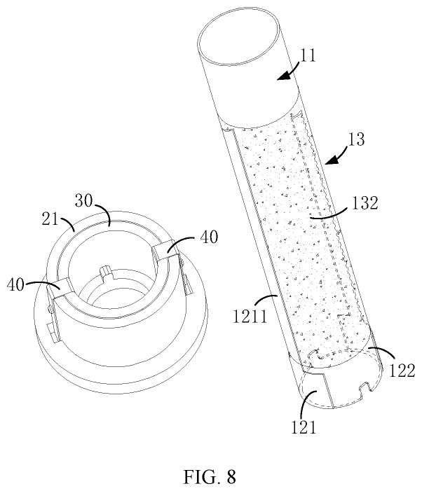

Referring to FIG. 8, in some other embodiments, the heating part 13 includes a radiation material layer 132, the radiation material layer 132 is attached on the surface of the tube body and configured to generate infrared radiation. The radiation material layer 132 is excited in the condition of electrical conduction to emit far infrared electromagnetic waves, thereby achieving the function of electric heating.

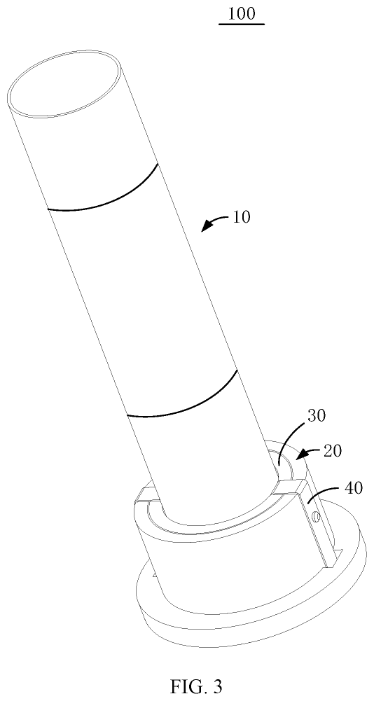

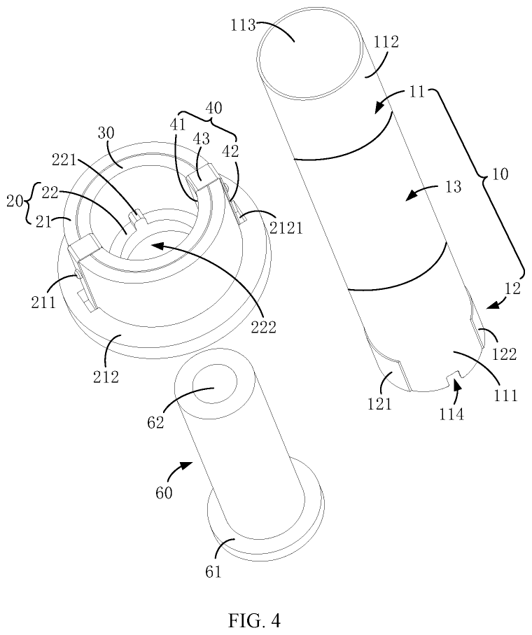

Referring to FIG. 3 and FIG. 4, the conductive part 12 is formed on the tube body 11. For example, the conductive part 12 includes a first conductive part 121 and a second conductive part 122, optionally, the first conductive part 121 and the second conductive part 122 are a metal coating formed on the surface of the tube body 11, wherein the heating part 13 that is formed on the tube body 11 is connected between the first conductive part 121 and the second conductive part 122. Here, the first conductive part 121 and the second conductive part 122 are spaced and distributed along a circumferential direction of the tube body 11; optionally, the first conductive part 121 and the second conductive part 122 are provided symmetrically along a central axis of the tube body. Optionally, at least part of the conductive part 12 extends along an axial direction of the tube body 11, for example, part of the first conductive part 121 extends along the axial direction of the tube body 11 to form an extension part 1211 (as shown in FIG. 8), the extension part 1211 electrically connects the first conductive part 121 and the heating part 13.

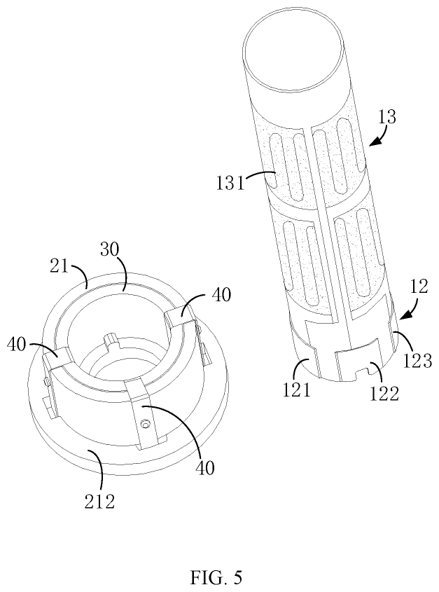

Referring to FIG. 5, in some other embodiments, the conductive part 12 further includes a third conductive part 123, another heating part 13 is connected between the third conductive part 123 and the second conductive part 122, wherein the heating part 13 connected between the first conductive part 121 and the second conductive part 122 and the another heating part 13 connected between the second conductive part 122 and the third conductive part 123 are configured to heat different portions of the tube body 11 respectively.

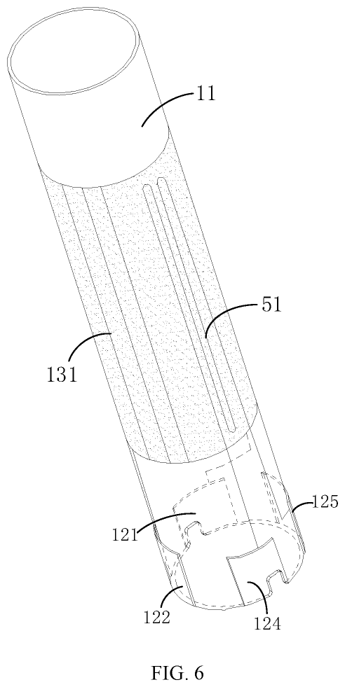

Referring to FIG. 6, in some other embodiments, the heating tube 10 further includes a temperature measurement circuit layer 51, and the temperature measurement circuit layer 51 is provided on the outside wall of the tube body 11. The temperature measurement circuit layer 51 is configured to detect the temperature of the tube body 11, so as to perform intelligent control on the heating part 13 to thus achieve the technical purpose of intelligent control of temperature. Further, the conductive part 12 further includes a fourth conductive part 124 and a fifth conductive part 125, the tube body 11 is further provided with the fourth conductive part 124 and the fifth conductive part 125. The temperature measurement circuit layer 51 is connected between the fourth conductive part 124 and the fifth conductive part 125.

Referring to FIG. 3 and FIG. 4, the base 20 includes a cylinder body 21. Optionally, the base 20 is made of a high-temperature resistant heat-insulating material. The heating tube 10 is detachably mounted within the cylinder body 21, or, the heating tube 10 is detachably sleeved on outside of the cylinder body 21. For example, the first end part 111 is detachably mounted within the cylinder body 21. The base 20 is provided with a circumferential stop part configured to prevent the tube body 11 from rotating, the circumferential stop part includes a positioning bulge 221 protruded and provided on one side of the base 20 facing the tube body 11, and a tube wall of the tube body 11 defines a positioning recess 114 matched with the positioning bulge 221. When the tube body 11 is assembled within the cylinder body 21, the positioning bulge 221 is in snap-fit with the positioning recess 114, thereby preventing the tube body 11 from a circumferential rotation relative to the base 20. Further, the base 20 is provided with an axial stop part configured to prevent the tube body 11 from an axial movement. Optionally, the axial stop part is a baseplate 22, and the baseplate 22 is fixed on one end of the cylinder body 21, to prevent the tube body 11 from an axial movement. Here, an inside of the baseplate facing the cylinder body 21 is provided with the positioning bulge 221 that is protruded.

The heating assembly 100 further includes an insulating element 30, and the insulating element 30 is provided between the base 20 and the tube body 11. In the present embodiment, the insulating element 30 is of a ring structure, the shape of the insulating element 30 is a ring shape fitting with the shape of the surface of the tube body 11. The insulating element 30 is accommodated within the cylinder body 21 or sleeved on outside of the cylinder body 21 correspondingly; in the present embodiment, the insulating element 30 is accommodated within the cylinder body 21 correspondingly, and an outside wall of the insulating element 30 abuts against an inside wall of the cylinder body 21. Optionally, the insulating element 30 is made of an insulating, high-temperature resistant heat-isolating elastic material, for example, the insulating element 30 is made of a silicone rubber, having an insulating, high-temperature resistant and sealing effect. In the present embodiment, the high-temperature resistant material refers to a high-temperature resistant material capable of withstanding over 240° C.

The heating assembly 100 further includes one or more conductive elements 40, the conductive element 40 is in a metal sheet shaped structure. The conductive element 40 is provided on the base 20 and abuts against the conductive part 12 to form an electric connection, for example, the conductive part 12 includes the first conductive part 121 and the second conductive part 122, then the base 20 is provided with two conductive elements 40 corresponding to the first conductive part 121 and the second conductive part 122.

Both of the first conductive part 121 and the second conductive part 122 are provided on one same end part of the tube body 11, or located on two opposite end parts of the tube body 11, for example, as shown in FIG. 7, the tube body 11 includes the first end part 111 and the second end part 112 that are opposite, the first conductive part 121 is provided on the first end part 111, and the second conductive part 122 is provided on the second end part 112, wherein the tube body 11 is provided with three bases 20, that is, the tube body 11 is provided with a first base, a second base and a third base, the first end part 111 is provided with the first base, the second end part 112 is provided with the second base, and the middle of the tube body 11 is provided with the third base; the conductive elements 40 on the first base and the second base are in electrical contact with the first conductive part 121 and the second conductive part 122 correspondingly. Further, the first conductive part 121 and/or the second conductive part 122 includes an annular electrode 1212 formed on the tube body 11.

Referring to FIG. 3 and FIG. 4, the conductive element 40 includes a first part 41 and a second part 42 that are electrically connected to each other. The first part 41 is located between the insulating element 30 and the tube body 11 and makes contact with the conductive part 12 to form an electric connection. The second part 42 deviates in the direction away from the tube body 11 with respect to the first part 41, for example, the second part 42 deviates along a radial direction of the tube body 11 with respect to the first part 41. The second part 42 is configured to be coupled with the power source 202, so that the power source 202 provides power support for the heating assembly 100. Optionally, the first part 41 corresponds to the conductive part 12 on the tube body 11 in terms of position, wherein the insulating element 30 is configured to enable the first part 41 to abut against the tube body 11 so that the first part 41 makes contact with the conductive part 12 on the tube body 11, to form an electric connection.

In the present embodiment, the base 20 and the insulating element 30 are together located between the first part 41 and the second part 42 of the conductive element 40, to separate the first part 41 from the second part 42. Optionally, the first part 41 and the second part 42 are provided on inside and outside of the cylinder body 21 correspondingly. Further, the conductive element 40 further includes a connection section 43 configured to connect the first part 41 and the second part 42, and the connection section 43 extends along the radial direction of the tube body 11.

One side of the cylinder body 21 far away from the insulating element 30 is provided with at least one fixing part configured to fasten the conductive element 40. The fixing part includes a fixing block 211 formed in a protruding manner on an outer or inner surface of the cylinder body 21; in the present embodiment, the outside of the cylinder body 21 is provided with the fixing block 211 that is protruded. The second part 42 defines thereon a fixing hole (not shown in figures) matched with the fixing block 211, the fixing block 211 is matched with the fixing hole to fasten the conductive element 40 onto the base 20. Further, the base 20 further includes a flange 212 extended out from the cylinder body 21, and the flange 212 defines thereon a receiving hole 2121 for an end portion of the second part 42 to pass through.

In the present embodiment, under the action of elastic pressing between the insulating element 30 and the tube body 11, the first part 41 abuts against and is fixed with the conductive part 12 to form an electric connection. In addition, the insulating element 30 that has an elastic performance can seal the connection between the tube body 11 and the base 20, thereby preventing the gas and/or liquid within the heating channel 113 entering one side of the conductive part 12, and achieving the function of protecting the circuit structure. In addition, the heating part 13 is electrically connected to the conductive part 12, the conductive part 12 is electrically connected to the first part 41 of the conductive element 40, the second part of the conductive element 40 is configured to be welded with a power supply circuit to form an electric connection structure, for example, the second part 42 of the conductive element 40 is electrically welded with an output end of the control circuit board 203. The conductive element 40 is electrically connected to the control circuit board 203, so that the power source 202 can provide power support for the heating part 13. During the operation process of the heating assembly 100, the heat inside the heating tube 10 is uneasy to transmit to the outside wall of the base 20, that is, the temperature of the second part 42 is much lower than the temperature of the first part 41, such that the welding point welded with the second part 42 is firm, not prone to damage, thus ensuring the quality of the product.

It is understandable that the conductive part 12 and the conductive element 40 are both made of a metal conductive material, for example, a copper or copper alloy material.

As shown in FIG. 4, further, the heating assembly 100 further includes a supporting tube 60. The supporting tube 60 is of a straight-line shaped tubular structure, and the supporting tube 60 includes an airflow channel 62. One opening of the airflow channel 62 is located on one end part of the supporting tube 60, while the other opening is located on the other opposite end part of the supporting tube 60, an outside wall of the supporting tube 60 is provided with a fixing element 61 which is protruded along the radial direction, and the fixing element 61 is roughly in a ring structure. One side of the baseplate 22 facing the cylinder body 21 defines a through receding hole 222, the supporting tube 60 passes through the receding hole 222 and is sleeved into the heating channel 113 within the first end part 111, so that the airflow channel 62 is communicated with the heating channel 113, the fixing element 61 is clamped on the edge of the receding hole 222, that is the fixing element 61 is in fixed connection with the baseplate 22.

In the present embodiment, a tube wall of the supporting tube 60 accommodated within the heating channel 113 serves as a supporting element, the cigarette 300 enters from the opening end of the heating channel 113 on the second end part 112 and abuts against the tube wall of the supporting tube 60, the cigarette 300 is located and housed within the heating channel 113 under the action of supporting of the tube wall of the supporting tube 60; when a user controls the heating part 13 to be electrically conducted, the heating part 13 starts to generate heat, and the cigarette 300 is heated under the action of the heat so that the user can inhale the cigarette 300. In addition, the insulating element 30 which is made of an elastic sealing material has a good sealing effect and thus achieves the function of protecting the circuit structure. When a user inhales a cigarette 300, the air flow passes through the airflow channel 62 and the heating channel 113 in turn and finally enters the mouth of the user, thus completing the inhalation action. The air circuit is stable in structure and smooth in airflow guide.

To sum up, the technical scheme of the present disclosure includes but not limited to the following advantages.

1. In the heating assembly 100 of the present embodiment, the first part 41 abuts against the conductive part 12 to form an electric connection, the second part 42 deviates in the direction away from the tube body 11 with respect to the first part 41, and the second part 42 may be welded with an external power source 202 to form an electric connection. During the operation process of the heating assembly 100, the heat is isolated by the insulating element 30, the temperature of the second part 42 is much lower than the temperature of the first part 41, thereby preventing the welding point welded with the second part 42 being damaged due to the effect of high temperature. The electric connection mode of the heating assembly 100 in the present embodiment makes the welding process simple and the welded structure point firm and not prone to damage.

2. The insulating element 30 and the conductive element 40 may be fixedly mounted on the base 20, however, the heating tube 10 is detachably mounted on the base 20, such that the assembly is easy and simple.

3. The insulating element 30 which is made of an elastic sealing material has a good sealing effect and thus achieves the function of protecting the circuit structure. When a user inhales a cigarette 300, the air flow passes through the airflow channel 62 and the heating channel 113 in turn and finally enters the mouth of the user, thus completing the inhalation action. The air circuit is stable in structure and smooth in airflow guide.

Finally, it should be noted that the above embodiments are merely to illustrate, but to limit, the technical scheme of the present disclosure. Under the thought of the present disclosure, technical features in the above embodiments or different embodiments may be combined, steps may be implemented in any order, and there exist many other changes of different aspects for what described above; for conciseness, they are not provided in detail. Although the present disclosure is described in detail with reference to the above embodiments, the ordinary skill in the art should understand that modifications are still possible for the technical schemes described in each above embodiment or partial technical schemes can be equivalently substituted; however, these modifications or substitutions do not get the essence of the technical scheme departed from the scope of the corresponding technical scheme in each embodiment of the present disclosure.

What is claimed is:

1. A heating tube comprising a tube body having a first end and a second end that is opposite to the first end, a heating part, and a conductive part comprising a first conductive part and a second conductive part, wherein:
the first conductive part and the second conductive part are disposed on the tube body and are in electrical connection with the heating part;
the first conductive part comprises a first electrode part and a first extension part;
the first electrode part is closer to the first end than the first extension part;
the first extension part extends from the first electrode part towards the second end;
the second conductive part comprises a second electrode part and a second extension part;
the second electrode part is closer to the first end than the second extension part;
the first extension part extends from the first electrode part towards the second end and at least a part of the first extension part is in direct contact with the heating part;
the second extension part extends from the second electrode part towards the second end;
an average circumferential width of the first electrode part is larger than an average circumferential width of the first extension part; and
an average circumferential width of the second electrode part is larger than an average circumferential width of the second extension part.

2. The heating tube according to claim 1, wherein:
the heating part is disposed on the tube body and is spaced apart from the first end, and a spacing region is formed between the heating part and the first end; and
the first electrode part and the second electrode part are both located on the spacing region.

3. The heating tube according to claim 1, wherein:
the first electrode part is spaced apart from the heating part; and
the second electrode part is spaced apart from the heating part.

4. The heating tube according to claim 1, wherein:
at least a part of the first extension part is in direct contact with the heating part; and
at least a part of the second extension part is in direct contact with the heating part.

5. The heating tube according to claim 1, wherein:
the tube body comprises an axial direction;
the tube body comprise a cavity configured for receiving an aerosol-generating product;
the cavity extends in the axial direction; and
at least one of the first extension part and the second extension part extends in the axial direction.

6. The heating tube according to claim 1, wherein the first extension part and the second extension part are arranged at intervals in a circumferential direction of the tube body.

7. The heating tube according to claim 6, wherein:
at least a part of the heating part is disposed between the first extension part and the second extension part; and
the at least a part of the heating part is in contact with the first extension part and the second extension part.

8. The heating tube according to claim 1, wherein the first electrode part and the second extension part are arranged at intervals in a circumferential direction of the tube body.

9. The heating tube according to claim 1, wherein at least one of the first electrode part and the second electrode part is in an annular ring shape.

10. The heating tube according to claim 1, wherein the first conductive part and the second conductive part are arranged symmetrically along a central axis of the tube body.

11. The heating tube according to claim 1, wherein at least one of the first extension part and the second extension part has a constant circumferential width.

12. The heating tube according to claim 1, wherein at least one of the first electrode part and the second electrode part has a constant circumferential width.

13. The heating tube according to claim 1, wherein the heating part comprises a radiation material layer disposed on a surface of the tube body and the radiation material layer is configured to generate infrared radiation.

14. The heating tube according to claim 1, wherein the conductive part is a metal coating.

15. The heating tube according to claim 1, comprising a tube wall and a positioning recess, wherein:
the tube wall extends between the first end and the second end; and
the positioning recess is disposed on the tube wall adjacent to the first end.

16. The heating tube according to claim 1, wherein:
the tube body comprises a cavity configured for receiving an aerosol-generating product; and
the heating part and the conductive part are arranged on an outer surface of the tube body.

17. An electronic smoking set, comprising a power source and the heating tube according to claim 1, wherein the power source is configured to supply power to the heating tube.

18. The electronic smoking set according to claim 17, wherein the conductive part is in electrical connection with the power source, and when the heating part is configured to generate heat when the power source supplies power to the conductive part.

19. The electronic smoking set according to claim 17, wherein the conductive part is in electrical connection with the power source through the first electrode part and the second electrode part.

20. The electronic smoking set according to claim 17, further comprising a shell comprising a insertion hole, wherein:
the heating tube is located inside the shell;
the heating tube comprises a cavity for receiving an aerosol-generating product;
the second end of the heating tube is closer to the insertion hole than the first end of the hating tube; and
the cavity of the heating tube is configured to receive the aerosol-generating product through the insertion hole.
